(19) United States
(12) Patent Application Publication
(10) Pub. No.: US 2018/0309915 A1
(43) Pub. Date: Oct. 25, 2018

(54) OPTICAL SCANNING OBSERVATION APPARATUS AND METHOD FOR ADJUSTING IRRADIATION PARAMETER OF PULSED LASER LIGHT

(71) Applicant: OLYMPUS CORPORATION, Tokyo (JP)

(72) Inventor: Yuhei TAKATA, Tokyo (JP)

(73) Assignee: OLYMPUS CORPORATION, Tokyo (JP)

(21) Appl. No.: 16/010,655

(22) Filed: Jun. 18, 2018

Related U.S. Application Data
(63) Continuation of application No. PCT/JP2015/006360, filed on Dec. 21, 2015.

(51) Int. Cl. H04N 5/225

(52) U.S. Cl. CPC H04N 5/2256; H04N 2005/2255

(57) ABSTRACT

An optical scanning observation apparatus includes a laser light source driver configured to emit pulsed laser light of different wavelengths sequentially from a plurality of laser light sources, a scanning unit, a laser light detector, an image processor, and a controller configured to control the laser light source driver so that a detection signal obtained by irradiation of the pulsed laser light of one wavelength and outputted from the laser light detector does not have a detection signal generated by irradiation of the pulsed laser light of a different wavelength substantially mixed therein.

### CROSS-REFERENCE TO RELATED APPLICATION

The present application is a Continuing Application based on International Application PCT/JP2015/006360 filed on Dec. 21, 2015, the entire disclosure of which is incorporated herein by reference.

### TECHNICAL FIELD

The present disclosure relates to an optical scanning observation apparatus for optically scanning an object and a method for adjusting an irradiation parameter of pulsed laser light.

### BACKGROUND

An optical scanning observation apparatus that obtains a color image of an observation target using red (R), green (G), and blue (B) laser light sources is known. Spectroscopic methods include a continuous light method for using a mixed wave of RGB continuous output as irradiation light, splitting detected light with a spectral filter, and measuring with a plurality of detectors; a frame sequential method for switching the RGB irradiation every frame and detecting with one detector; and a pixel sequential method (time-division modulation method) for switching the RGB irradiation every pixel and detecting with one detector. For example, see patent literature (PTL) 1.

The frame sequential method and time-division modulation method do not require a spectroscope and detectors corresponding to each color and are therefore useful for reducing size and cutting costs. On the other hand, the time-division modulation method can acquire images of each RGB color within the same frame, yielding the advantage of no color flicker due to movement of the field of view, as occurs with the frame sequential method.

### CITATION LIST

### Patent Literature

PTL 1: US20060226231A1

### SUMMARY

An optical scanning observation apparatus according to one aspect includes:

a laser light source driver configured to emit pulsed laser light of different wavelengths sequentially from a plurality of laser light sources:

a scanning unit configured to irradiate the pulsed laser light on an object to scan the object;

a laser light detector configured to sequentially detect light obtained from the object by sequential irradiation of the pulsed laser light;

an image processor configured to generate an image of the object based on a detection signal outputted from the laser light detector; and

a controller configured to control the laser light source driver so that a detection signal obtained by irradiation of the pulsed laser light of one wavelength and outputted from the laser light detector does not have a detection signal generated by irradiation of the pulsed laser light of a different wavelength substantially mixed therein.

In the optical scanning observation apparatus, the controller may be configured to adjust an irradiation parameter of the plurality of laser light sources through the laser light source driver.

In the optical scanning observation apparatus, the controller may be configured to judge, in an adjustment mode for adjusting the irradiation parameter, whether a detection signal outputted from the laser light detector during a predetermined sampling period falls within a predetermined range relative to the predetermined sampling period.

In the optical scanning observation apparatus, when the detection signal outputted from the laser light detector during the predetermined sampling period is outside of the predetermined range relative to the predetermined sampling period, the controller may be configured to change an irradiation parameter of each pulsed laser light of at least one wavelength so that the detection signal falls within the predetermined range.

In the optical scanning observation apparatus, the irradiation parameter may be at least one of an irradiation command timing or a pulse width.

A method for adjusting an irradiation parameter of pulsed laser light according to a first aspect includes:

driving a laser light source to emit pulsed laser light from the laser light source;

irradiating the pulsed laser light on an object to scan the object:

detecting light obtained from the object by irradiation of the pulsed laser light; and

adjusting an irradiation parameter of the pulsed laser light, when a detection signal obtained in the detecting during a predetermined sampling period is outside of a predetermined range relative to the predetermined sampling period, so that the detection signal falls within the predetermined range.

A method for adjusting an irradiation parameter of pulsed laser light according to a second aspect includes:

driving a plurality of laser light sources to emit pulsed laser light of different wavelengths sequentially from the plurality of laser light sources;

irradiating the pulsed laser light on an object to scan the object;

detecting light obtained from the object by sequential irradiation of the pulsed laser light; and

adjusting an irradiation parameter of each pulsed laser light of at least one wavelength, when a detection signal obtained in the detecting by irradiation of the pulsed laser light of one wavelength has mixed therein a detection signal generated by irradiation of the pulsed laser light of a different wavelength, to reduce mixing of the detection signals.

In the method for adjusting an irradiation parameter according to the second aspect, the irradiation parameter of each pulsed laser light of at least one wavelength may be adjusted when a detection signal obtained in the detecting during a predetermined sampling period is outside of a predetermined range relative to the predetermined sampling period.

In the method for adjusting an irradiation parameter according to the first or second aspect, the irradiation parameter may be at least one of an irradiation command timing or a pulse width.

### BRIEF DESCRIPTION OF THE DRAWINGS

In the accompanying drawings:

FIG. 1 is a block diagram schematically illustrating the configuration of a first embodiment of an optical scanning observation apparatus;

FIG. 2 is a schematic overview of the scope in FIG. 1;

FIG. 3 is a cross-sectional view of the tip of the scope in FIG. 2:

FIG. 4A is a side view, and FIG. 4B is a cross-sectional view along the A-A line in FIG. 4A, illustrating the driver and the oscillating portion of the optical fiber for illumination in FIG. 3;

FIG. 5 is an outline illustrating a first embodiment of a method for adjusting an irradiation parameter;

FIG. 6 is a flowchart of the first embodiment of a method for adjusting an irradiation parameter;

FIG. 7 is a time chart illustrating an example of a control signal for each laser light source after adjustment of the irradiation parameter and detection signals from an optical detector;

FIG. 8 is an outline illustrating the relationship between the irradiation command timing of laser light and the actual irradiation area in the example in FIG. 7;

FIG. 9 is an outline illustrating a second embodiment of a method for adjusting an irradiation parameter;

FIG. 10 is a flowchart of the second embodiment of a method for adjusting an irradiation parameter;

FIG. 11 is an outline illustrating a third embodiment of a method for adjusting an irradiation parameter:

FIG. 12 is a flowchart of the third embodiment of a method for adjusting an irradiation parameter;

FIG. 13 is a block diagram schematically illustrating the configuration of a modification to an optical scanning observation apparatus:

FIGS. 14A to 14C illustrate a modification to the actuator in FIG. 4A, where FIG. 14A is a cross-sectional view of the tip of the scope, FIG. 14B is an enlarged perspective view of the actuator in FIG. 14A, and FIG. 14C is a cross-sectional view along a plane perpendicular to the axis of the optical fiber, illustrating a portion including the coils for generation of a deflecting magnetic field and the permanent magnet in FIG. 14B; and

FIG. 15 is an outline illustrating a known optical scanning observation apparatus.

### DETAILED DESCRIPTION

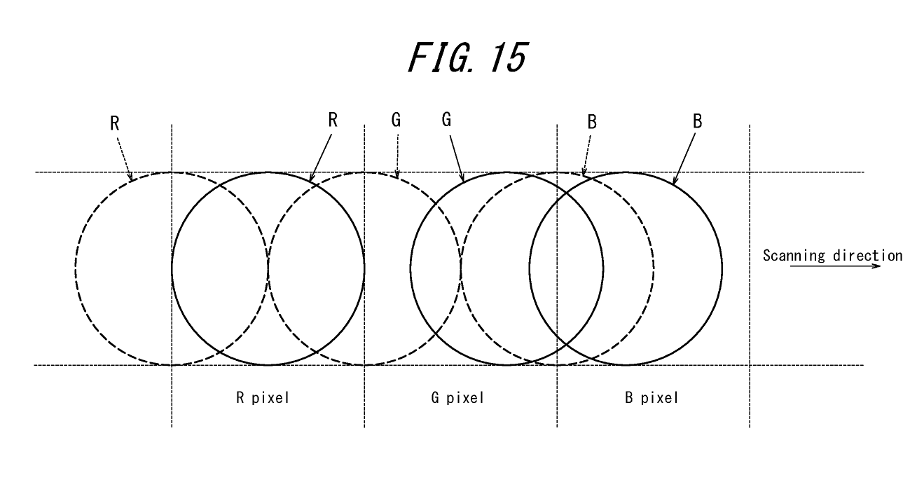

In general, RGB laser light sources have different response characteristics. In greater detail, the length of time from the timing at which the laser light source receives an irradiation command (irradiation command timing) until the timing at which laser light is actually irradiated onto an object (actual irradiation timing) differs between the RGB laser light sources. In FIG. 15, the dashed RGB circles indicate virtual irradiation areas of RGB colored laser light if laser light of each color were irradiated onto an object simultaneously with the irradiation command timing, whereas the solid RGB circles indicate actual irradiation areas of RGB color laser light on an object. In the time-division modulation method, the actual irradiation areas of the RGB colors during a scan are shifted by relatively different amounts from the detection (sampling) area of the RGB pixels by the detector because of different response characteristics among the RGB laser light sources, as illustrated in FIG. 15. This causes color leaking, in which the actual irradiation area of one color spreads into a plurality of adjacent pixel sampling areas, leading to reduced image quality.

Embodiments are described below with reference to the drawings.

### First Embodiment

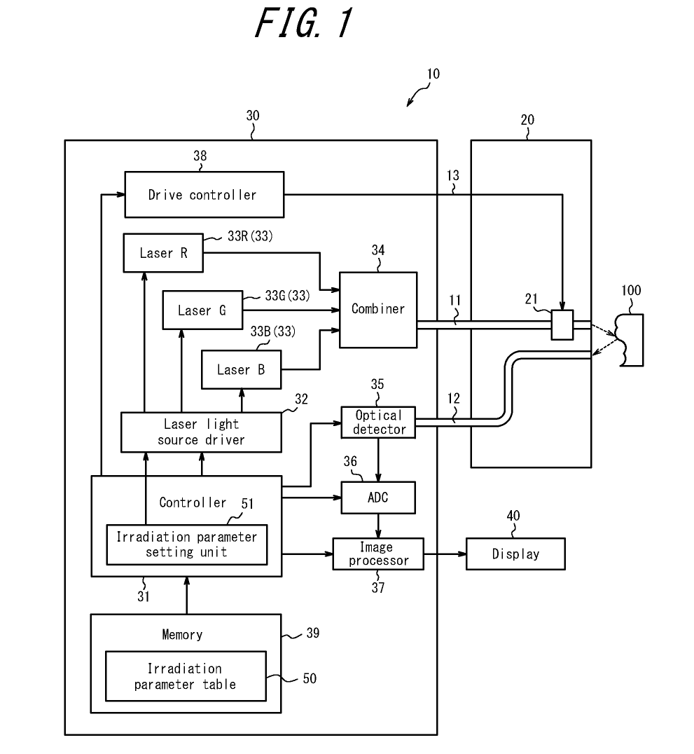

First, with reference to FIGS. 1 to 4B, a first embodiment of an optical scanning observation apparatus according to the present disclosure is described. FIG. 1 is a block diagram schematically illustrating the configuration of an optical scanning observation apparatus according to the first embodiment. In FIG. 1, an optical scanning observation apparatus 10 is configured as an optical scanning endoscope apparatus and includes a scope 20, a control device body 30, and a display 40.

First, the configuration of the control device body 30 is described. The control device body 30 includes a memory 39, a controller 31 that controls the optical scanning observation apparatus 10 overall, a laser light source driver 32, laser light sources 33R, 33G 33B (also collectively referred to hereinafter as “laser light source 33”), a combiner 34, a drive controller 38, an optical detector 35, an analog-digital converter (ADC) 36, and an image processor 37.

The light sources 33R. 33Q 33B emit pulsed laser light of R, G and B wavelengths (hereinafter also simply “colors”) in accordance with the control signal (irradiation command) from the laser light source driver 32. For example, diode-pumped solid-state (DPSS) lasers or laser diodes may be used as the laser light sources 33R, 33G, 33B.

The memory 39 holds an irradiation parameter table 50, such as the one in Table 1 below, storing an irradiation parameter (an irradiation timing t in this example) of pulsed laser light for each wavelength (R, G, B) of pulsed laser light from the laser light sources 33R, 33G, 33B.

The irradiation timings t_{R}, t_{G}, t_{B} of the colors R, G, B are parameters stipulating the irradiation command timing of each color (the timing at which the laser light sources 33R, 33G, 33B receive the irradiation command from the laser light source driver 32). In this example, the irradiation timings t_{R}, t_{G}, t_{B} of the colors indicate the amount of time by which to speed up or delay the initial value of the irradiation command timing of each color (i.e. a time shift for the initial value of the irradiation command timing) and are set by performing, in advance, a method for adjusting an irradiation parameter of pulsed laser light (hereinafter also simply “method for adjusting an irradiation parameter”) using the optical scanning observation apparatus 10, as described below. In this example, the initial value of the irradiation command timing of each color is set to the irradiation command timing of each color for the case of irradiating pulsed laser light at constant time intervals (irradiation period) T_{E} in a predetermined irradiation order (in the order R, G, B).

TABLE 1

| | Irradiation timing t |
|---|---|
| R | t_{R} |
| G | t_{G} |
| B | t_{B} |

The method for adjusting an irradiation parameter is used at a time other than a regular scan for observing an object 100, such as when shipping the produced optical scanning observation apparatus 10, at the time of maintenance, or immediately before a scan. For the sake of convenience, the mode of the optical scanning observation apparatus 10 when performing the method for adjusting an irradiation parameter is referred to as “adjustment mode”, and the mode of the optical scanning observation apparatus 10 when performing a normal scan for observing the object 100 is referred to as “scanning mode”.

The irradiation parameter may, for example, be adjusted manually in the optical scanning observation apparatus 10 only at the time of product shipment, in which case the system of the shipped optical scanning observation apparatus 10 need not include the “adjustment mode”.

The controller 31 includes an irradiation parameter setting unit 51. Before a scan, the irradiation parameter setting unit 51 reads the irradiation parameter (irradiation timing t) of each of the colors R, G B from the parameter table 50 in the memory 39 and sets (corrects) the irradiation command timing of each of the colors R, G % B. During a scan, the controller 31 controls the laser light source driver 32 using the set irradiation command timings.

By controlling the laser light source driver 32 using the set irradiation command timings, the controller 31 can perform control so that a detection signal obtained by irradiation of pulsed laser light of one of the wavelengths of R, G, or B and outputted from the optical detector 35 does not have a detection signal generated by irradiation of pulsed laser light of a different wavelength substantially mixed therein, as described below. Here, “not substantially mixed therein” refers to the signal of detected laser light of another wavelength being less than 5%.

The laser light source driver 32 sequentially emits R, G, B pulsed laser light from the laser light sources 33R, 33G, 33B in accordance with the control signal from the controller 31. During one scan, the laser light source driver 32 repeatedly switches between the wavelengths of R, G, B light from the laser light source 33 in a predetermined irradiation order (such as the order R, G B) in accordance with the irradiation command timing of each color.

As used here, “one scan” refers to one scan, in order to capture one image (one frame), from the starting point to the ending point of a predetermined scan path, such as a spiral.

The pulsed laser light emitted from the laser light sources 33R, 33G 33B passes through optical paths joined coaxially by the combiner 34 and is incident as illumination light on a light-transmission fiber 11, which is a single-mode fiber.

The combiner 34 may, for example, be configured using a fiber multiplexer, a dichroic prism, or the like.

The laser light sources 33R, 33G, 33B and the combiner 34 may be stored in a housing that is separate from the control device body 30 and is joined to the control device body 30 by a signal wire.

Pulsed laser light incident on the light-transmission fiber 11 (scanning unit) from the combiner 34 is guided to the tip of the scope 20 and irradiated onto an object 100. At this time, by driving the actuator 21 (scanning unit) of the scope 20 by vibration, the drive controller 38 of the control device body 30 drives the tip of the light-transmission fiber 11 by vibration. As a result, the illumination light (pulsed laser light) emitted from the light-transmission fiber 11 scans the observation surface of the object 100 in 2D over a predetermined scan path. Light such as reflected light or scattered light that is obtained from the object 100 due to sequential irradiation with the pulsed laser light is received at the tip of a light-receiving fiber 12, which is constituted by a multi-mode fiber, and is guided through the scope 20 to the control device body 30.

In this example, the light-transmission fiber 11 and the actuator 21 constitute a scanning unit that irradiates pulsed laser light from the laser light source 33 onto the object 100 to scan the object 100.

Through the light-receiving fiber 12, the optical detector 35 (laser light detector) sequentially detects (samples) light obtained from the object 100 by sequential irradiation of R, G, B pulsed laser light and outputs an analog detection signal every irradiation period T_{E} of pulsed laser light.

The period for the optical detector 35 to sample R, G B light obtained from the object 100 is referred to below as the “sampling period”. The time length of the sampling period in scanning mode is set to be the same as the irradiation period T_{E}. As described below, the sampling period in adjustment mode is set when performing the method for adjusting an irradiation parameter.

The ADC 36 converts the analog detection signal from the optical detector 35 to a digital detection signal and outputs the result to the image processor 37.

In the first embodiment, the detection signal outputted from the optical detector 35 via the ADC 36 is accumulated in any storage device (such as the memory 39 of the control device body 30 or a non-illustrated external storage device).

The image processor 37 stores the detection signal, sequentially input from the ADC 36, corresponding to each wavelength sequentially in any storage apparatus (not illustrated) in association with the respective irradiation command timings and scanning positions. Information on the irradiation command timing and scanning position is obtained from the controller 31. The controller 31 calculates information on the scanning position along the scan path from information such as the amplitude and phase of vibration voltage applied by the drive controller 38. Instead of calculating the information on the scanning position, the controller 31 may store therein, in advance, a table stipulating the relationship between the scanning time and the scanning position in correspondence with predetermined scanning conditions. The controller 31 may then read information on the scanning position from the table and transmit the information to the image processor 37.

In this example, the scanning position information of each color can be applied as is even when the irradiation command timing of each color is adjusted (corrected).

After completion of scanning or during scanning, the image processor 37 generates an image signal after performing image processing as necessary, such as enhancement, γ processing, and interpolation, based on each detection signal input from the ADC 36 and displays an image of the object 100 on the display 40.

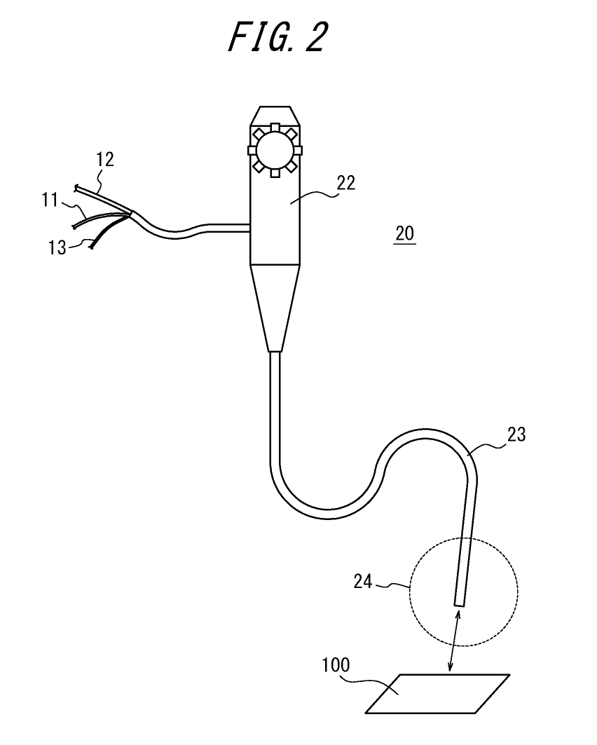

Next, the configuration of the scope 20 is described. FIG. 2 is a schematic overview of the scope 20. The scope 20 includes an operation part 22 and an insertion part 23. The light-transmission fiber 11, the light-receiving fiber 12, and wiring cables 13 that extend from the control device body 30 are each connected to the operation part 22. The light-transmission fiber 11, light-receiving fiber 12, and wiring cables 13 pass through the insertion part 23 and extend to a tip 24 (the portion within the dashed line in FIG. 2) of the insertion part 23.

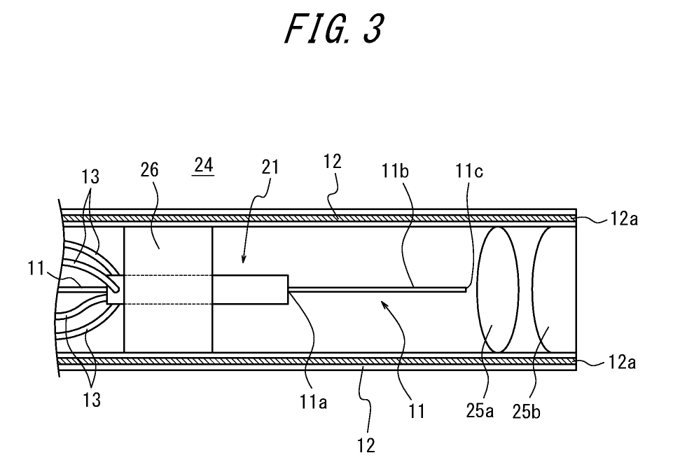

FIG. 3 is a cross-sectional view illustrating an enlargement of the tip 24 of the insertion part 23 in the scope 20 in FIG. 2. The tip 24 of the insertion part 23 of the scope 20 includes the actuator 21, projection lenses 25a and 25b, the light-transmission fiber 11 that passes through the central portion, and a plurality of light-receiving fibers 12 that pass through the peripheral portion.

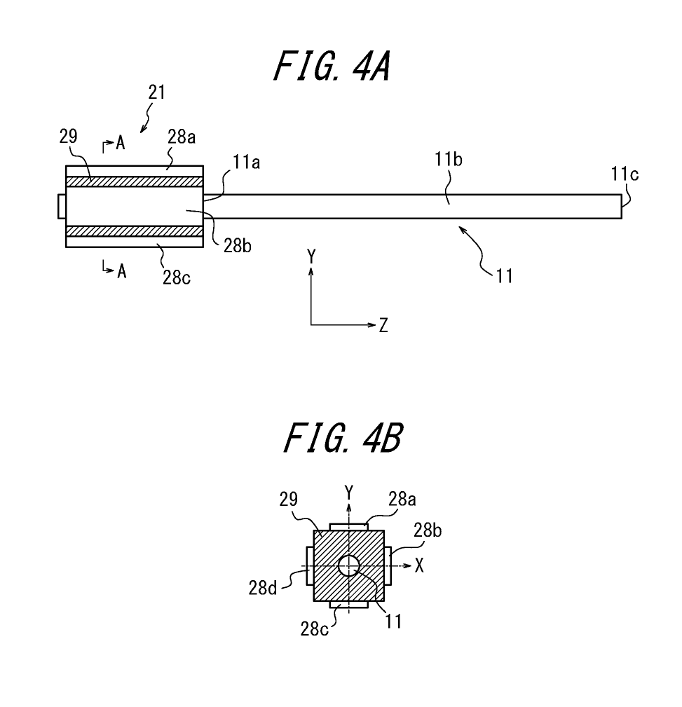

The actuator 21 drives a tip 11c of the light-transmission fiber 11 by vibration. The actuator 21 includes a fiber holding member 29 fixed to the inside of the insertion part 23 of the scope 20 by an attachment ring 26 and piezoelectric elements 28a to 28d (see FIGS. 4A and 4B). The light-transmission fiber 11 is supported by the fiber holding member 29, and the portion of the light-transmission fiber 11 from a fixed end 11a supported by the fiber holding member 29 to the tip 11c is an oscillating part 11b that is supported to allow oscillation. The light-receiving fiber 12 is disposed to pass through the peripheral portion of the insertion part 23 and extends to the end of the tip 24. A non-illustrated detection lens is also provided at the tip of each fiber in the light-receiving fiber 12.

Furthermore, the projection lenses 25a and 25b and the detection lenses are disposed at the extreme end of the tip 24 of the insertion part 23 in the scope 20. The projection lenses 25a and 25b are configured so that laser light emitted from the tip 11c of the light-transmission fiber 11 is irradiated on the object 100 and substantially concentrated. The detection lenses are disposed so as to capture light that is reflected, scattered, or the like by the object 100 due to laser light concentrated on the object 100, and to concentrate and combine the captured light on the light-receiving fiber 12 disposed behind the detection lenses. The projection lenses are not limited to a double lens structure and may be structured as a single lens or as three or more lenses.

FIG. 4A illustrates the vibration driving mechanism of the actuator 21 of the optical scanning observation apparatus 10 and illustrates the oscillating part 11b of the light-transmission fiber 11. FIG. 4B is a cross-sectional view along the A-A line in FIG. 4A. The light-transmission fiber 11 passes through the center of the fiber holding member 29, which is shaped as a quadratic prism, and is fixed and held by the fiber holding member 29. The four sides of the fiber holding member 29 respectively face the ±Y direction and the ±X direction. A pair of piezoelectric elements 28a and 28c for driving in the Y direction are fixed onto the sides of the fiber holding member 29 in the +Y direction, and a pair of piezoelectric elements 28b and 28d for driving in the X direction are fixed onto the sides in the ±X direction.

The wiring cables 13 from the drive controller 38 of the control device body 30 are connected to the piezoelectric elements 28a to 28d, which are driven by application of voltage by the drive controller 38.

Voltage of equivalent magnitude and opposite polarity is always applied across the piezoelectric elements 28b and 28d in the X direction. Similarly, voltage of equivalent magnitude and opposite polarity is always applied across the piezoelectric elements 28a and 28c in the Y direction. One of the piezoelectric elements 28b and 28d disposed opposite each other with the fiber holding member 29 therebetween expands and the other contracts, causing the fiber holding member 29 to flex. Repeating this operation produces vibration in the X direction. The same is true for vibration in the Y direction as well.

The drive controller 38 can perform vibration driving of the piezoelectric elements 28b and 28d for driving in the X direction and the piezoelectric elements 28a and 28c for driving in the Y direction by applying vibration voltage of the same frequency or vibration voltage of different frequencies thereto. Upon vibration driving of the piezoelectric elements 28a and 28c for driving in the Y direction and the piezoelectric elements 28b and 28d for driving in the X direction, the oscillating part 11b of the light-transmission fiber 11 illustrated in FIGS. 3, 4A, and 4B vibrates, and the tip 11c is deflected. Hence, the pulsed laser light emitted from the tip 11c sequentially scans the surface of the object 100 over a predetermined scan path.

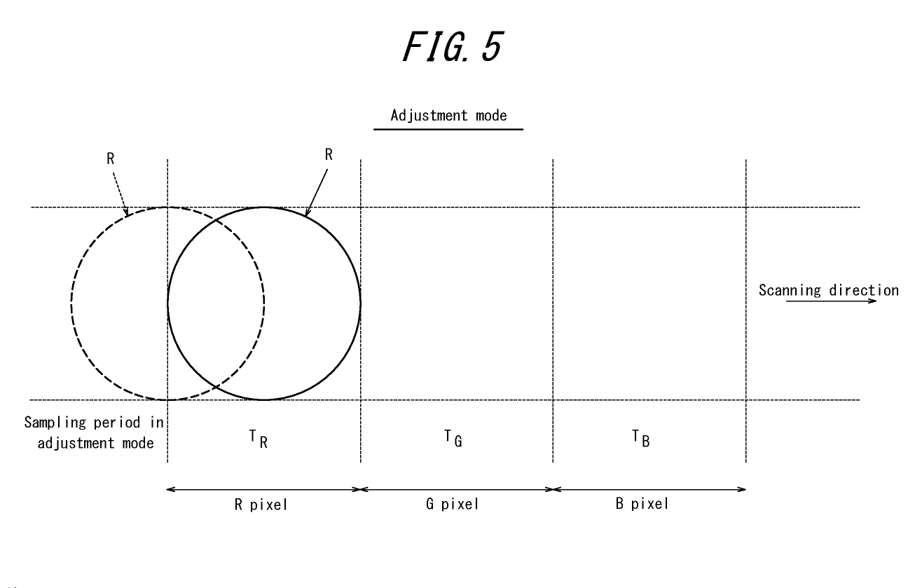

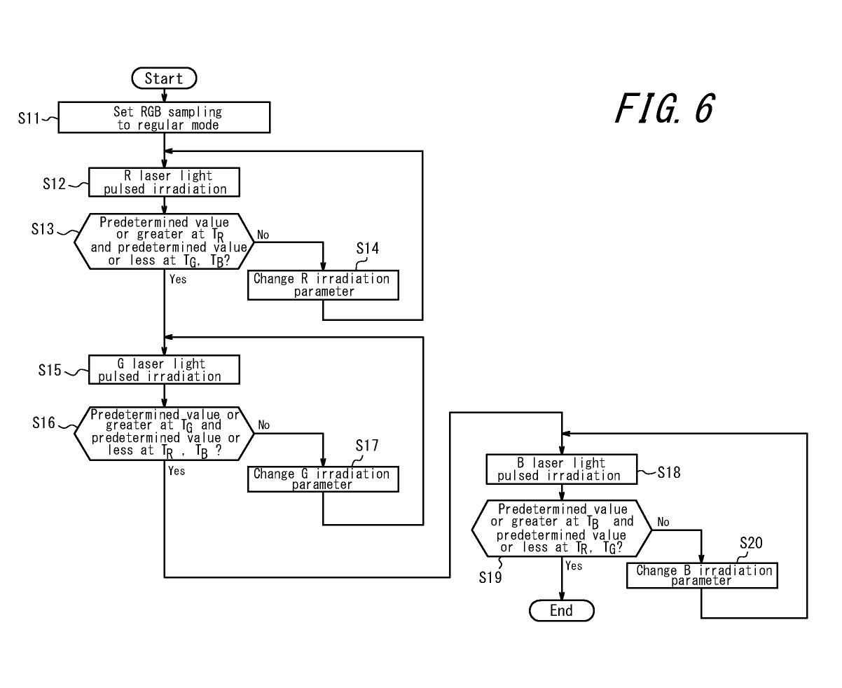

Next, the first embodiment of the disclosed method for adjusting an irradiation parameter of pulsed laser light is described with reference to FIGS. 5 and 6. In FIG. 5, the dashed R circle indicates a virtual irradiation area of R laser light if R laser light were irradiated simultaneously with the R irradiation command timing, whereas the solid R circle indicates the actual irradiation area of R laser light on an object. As described above, the irradiation parameter t of pulsed laser light from the laser light sources 33R, 33G, 33B (in this example, irradiation timings t_{R}, t_{G}, t_{B}) is adjusted by performing the method for adjusting an irradiation parameter of pulsed laser light using the optical scanning observation apparatus 10 in adjustment mode.

In the first embodiment, pulsed laser light of one color among R, G B is emitted while scanning over a predetermined scan path, the occurrence of color leaking is detected during each R, G B sampling period, and the irradiation parameter of the color is adjusted if color leaking has occurred. This process is repeated for the three colors. Any object may be used as the object 100, such as a white board.

First, the R, G, B sampling periods in adjustment mode are set to be the same as the sampling periods used in scanning mode to acquire an image of R, G, B pixels (step S11). The “sampling period” in the present disclosure is determined by the sampling frequency and timing.

As illustrated in FIGS. 5 and 6, the laser light source driver 32 outputs an irradiation command to the laser light source 33R upon reaching the R irradiation command timing during a scan, thereby causing R pulsed laser light to be emitted (step S12, laser light source driving step). The pulsed laser light from the laser light source 33R is irradiated onto the object 100 and scanned over the object 100 (scanning step) by the light-transmission fiber 11 and the actuator 21 (scanning unit). Light obtained from the object 100 is detected by the optical detector 35 in the sampling period T_{R} for the R pixel and in the subsequent sampling periods T_{G}, T_{B} of the G pixel and the B pixel (optical detection step).

Next, it is judged whether the detection signals outputted from the ADC 36 in the sampling periods T_{R}, T_{G}, T_{B} are within predetermined ranges for the sampling periods T_{R}, T_{G}, T_{B} (step S13). The actual irradiation area (solid circle) of the R pixel is ideally contained within the R sampling area (scan area). If at least a portion of the actual R irradiation area is present in the sampling area of another color (G, B), then R color leaking has occurred. Therefore, the detection signal is preferably as high as possible in the R sampling period T_{R} and preferably as low as possible in the G, B sampling periods T_{G}, T_{B}. From this perspective, in the example in FIG. 6, the predetermined range of the R sampling period T_{R} is a range of a predetermined value S_{R} or greater, and the predetermined ranges of the G, B sampling periods T_{G}, T_{B} are ranges of predetermined values S_{G}, S_{B} or less.

For example, the threshold (predetermined value S_{R}) of the aforementioned predetermined range of the R sampling period T_{R} may be 90% of the R peak amount of light, and the thresholds (predetermined values S_{G}, S_{B}) of the aforementioned predetermined ranges of the G, B sampling periods T_{G}, T_{B} may each be 5% of the R peak amount of light. The R peak amount of light can, for example, be acquired by changing the R irradiation parameter in all steps.

When at least one of the detection signals in the sampling periods T_{R}, T_{G}, T_{B} is outside of the aforementioned predetermined ranges (S13: No), then the R irradiation timing t_{R} is changed (step S14), and the changed irradiation timing t_{R} is stored in the irradiation parameter table 50 of the memory 39. The R irradiation timing t_{R} is further adjusted by subsequently repeating steps S12 to S14 until all of the detection signals in the sampling periods T_{R}, T_{G}, T_{B} respectively fall within the aforementioned predetermined ranges (adjustment step). The irradiation timing t_{R} is preferably changed in step S14 taking into consideration the detection signal in the sampling period T_{R} in the preceding step S13.

On the other hand, when all of the detection signals in the sampling periods T_{R}, T_{G}, T_{B} respectively fall within the aforementioned predetermined ranges in step S13 (S13: Yes), the process proceeds to step S15, and a similar process as for R in steps S12 to S14 is performed for G. Specifically, the laser light source driver 32 outputs an irradiation command to the laser light source 33G upon reaching the G irradiation command timing, thereby causing G pulsed laser light to be emitted (step S15). Subsequently, light obtained from the object 100 is detected by the optical detector 35 in the G sampling period T_{G} and in the subsequent B, R sampling periods T_{B}, T_{R}. When at least one of the detection signals outputted from the optical detector 35 through the ADC 36 in the sampling periods T_{R}, T_{G}, T_{B} is outside of predetermined ranges for the sampling periods T_{R}, T_{G}, T_{B} (S16: No), then the G irradiation timing t_{G} is changed (step S17). The G irradiation timing t_{G} is further adjusted by subsequently repeating steps S15 to S17 until all of the detection signals in the sampling periods T_{R}, T_{G}, T_{B} respectively fall within the aforementioned predetermined ranges. Here, as in the case of R, the detection signal is preferably as high as possible in the G sampling period T_{G} and preferably as low as possible in the B, R sampling periods T_{B}, T_{R}. Hence, in the example in FIG. 6, the predetermined range of the G sampling period T_{G} is a range of a predetermined value S_{G} or greater, and the predetermined ranges of the B, R sampling periods T_{B}, T_{R} are ranges of predetermined values S_{B}, S_{R} or less.

For example, the threshold (predetermined value S_{G}) of the aforementioned predetermined range of the G sampling period T_{G} may be 90% of the G peak amount of light, and the thresholds (predetermined values S_{B}, S_{R}) of the aforementioned predetermined ranges of the B, R sampling periods T_{B}, T_{R} may each be 5% of the G peak amount of light. The G peak amount of light can, for example, be acquired by changing the G irradiation parameter in all steps.

Subsequently, a similar process as for R and G is performed for B (steps S18 to S20).

Adjustment of the irradiation parameter (irradiation timings t_{R}, t_{G}, t_{B}) of each color R, G, B is completed by the above process.

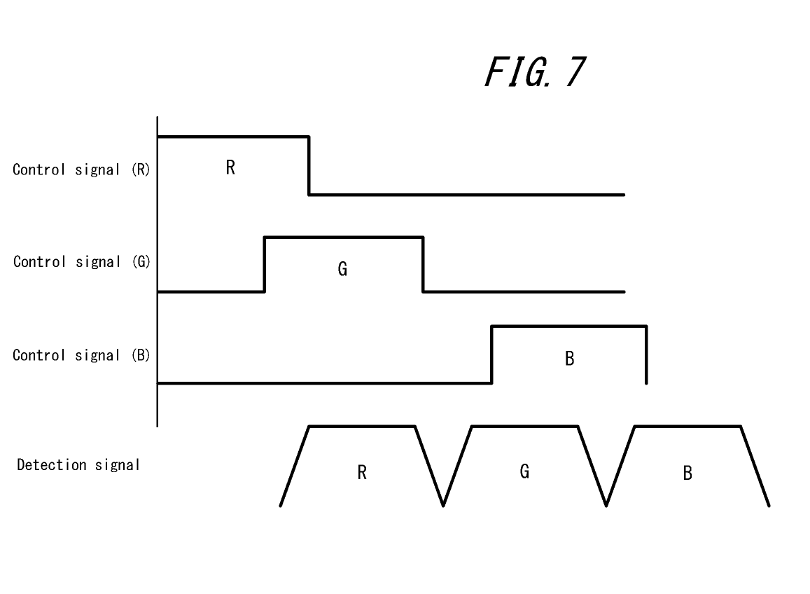

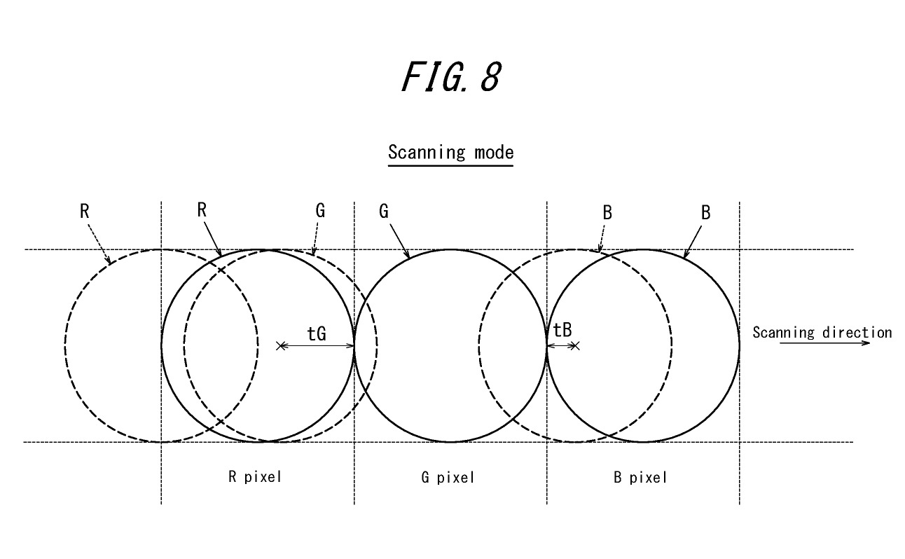

FIGS. 7 and 8 represent the performance of the optical scanning observation apparatus 10 in scanning mode after adjustment of the irradiation parameters. In the time chart in FIG. 7, the “control signal (R)”, “control signal (G)”, and “control signal (B)” respectively indicate the timings at which an irradiation command (control signal) is outputted from the laser light source driver 32 to the R, G B laser light sources 33R, 33G 33B, and the “detection signal” indicates the detection signal outputted from the optical detector 35 in the sampling period in scanning mode. In the outline in FIG. 8, the dashed circles indicate virtual irradiation areas at the irradiation command timings, whereas the solid circles indicate the actual irradiation areas.

In this example, the responsiveness of the G laser light source 33G is the slowest and the responsiveness of the B laser light source 33B is the fastest among the laser light sources 33R, 33G, 33B. Accordingly, the G irradiation command timing is set earlier than the initial value by the irradiation timing t_{G}, and the B irradiation command timing is set later than the initial value by the irradiation timing t_{B} (t_{G}>t_{R}>t_{B}, and t_{R}=0).

Consequently, the actual R, G, B irradiation areas (solid circles in FIG. 8) do not overlap and are contained within the respective color sampling areas, as illustrated in FIG. 8. Furthermore, the value of the detection signals generated by irradiation of R, G, B pulsed laser light are nearly uniform, as illustrated in FIG. 7. The detection signal obtained by irradiation of pulsed laser light of one wavelength is therefore prevented from having a detection signal generated by irradiation of pulsed laser light of a different wavelength substantially mixed therein, and color leaking is reduced. Image quality thus improves.

### Second Embodiment

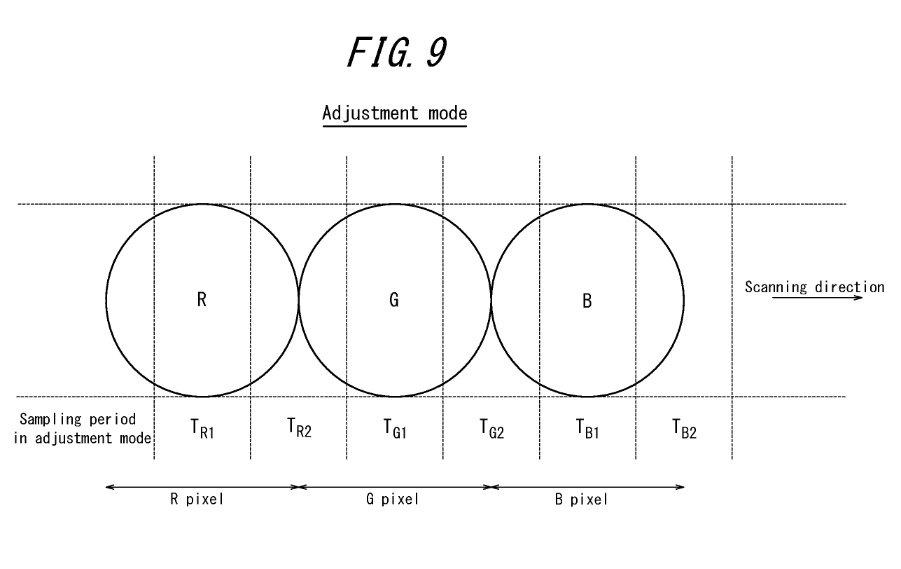

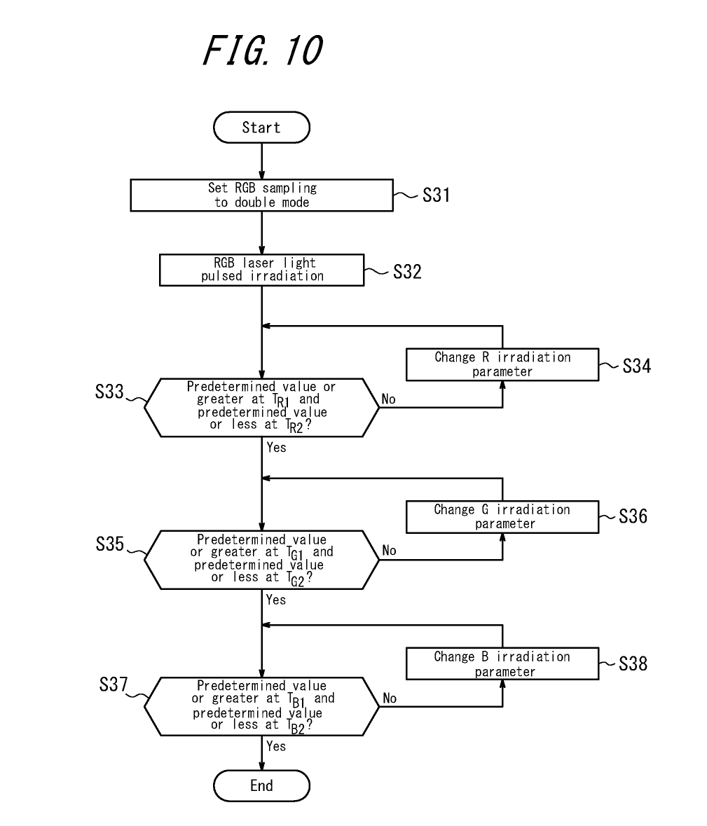

Next, a second embodiment of the disclosed method for adjusting an irradiation parameter of pulsed laser light is described with reference to FIGS. 9 and 10, focusing on the differences from the first embodiment. The optical scanning observation apparatus 10 described above with reference to FIGS. 1 to 4B is used in the below-described second embodiment of a method for adjusting an irradiation parameter.

In the second embodiment of a method for adjusting an irradiation parameter, R, G, B pulsed laser light is emitted sequentially while scanning along a predetermined scan path. When a detection signal obtained by irradiation of pulsed laser light of one wavelength has a detection signal generated by irradiation of pulsed laser light of another wavelength mixed therein, an irradiation parameter of each pulsed laser light of at least one wavelength is adjusted to reduce the mixing of detection signals.

First, the R, G, B sampling frequencies in this adjustment mode are set to be twice the sampling frequencies used in the scanning mode. Furthermore, periods T_{R1}, T_{G1}, T_{B1} corresponding to the central half of a pixel in each of the R, G, B pixel sampling periods in the scanning mode and periods T_{R2}, T_{G2}, T_{B2} corresponding to half of a pixel and spreading into the sampling periods of adjacent pixels of two colors in the scanning mode are alternately set (step S31).

As illustrated in FIGS. 9 and 10, the laser light source driver 32 sequentially outputs irradiation commands to the laser light sources 33R, 33G, 33B during a scan on the basis of the irradiation parameter t (irradiation timings t_{R}, t_{G}, t_{B}) stored in the irradiation parameter table 50 in the memory 39 to cause R, G, B pulsed laser light to be emitted sequentially (step S32, laser light source driving step). Step S32 is performed continuously while the following steps S33 to S38 are performed. The pulsed laser light from the laser light source 33 is irradiated onto the object 100 and scanned over the object 100 (scanning step) by the light-transmission fiber 11 and the actuator 21 (scanning unit). Light obtained from the object 100 is detected by the optical detector 35 in the sampling periods T_{R1}, T_{R2}, T_{G1}, T_{G2}, T_{B1}, T_{B2} (optical detection step). The detection signals outputted from the optical detector 35 in the sampling periods T_{R1}, T_{R2}, T_{G1}, T_{G2}, T_{B1}, T_{B2} are converted from analog to digital by the ADC 36.

Next, it is judged whether the detection signals in the sampling period T_{R1} corresponding to the central half of the R pixel and in the following sampling period T_{R2} spreading into the R pixel and the G pixel are both within respective predetermined ranges for the sampling periods T_{R1}, T_{R2} (step S33). Ideally, the central portion in the scanning direction of the R irradiation area (the peak portion in the laser waveform) is the central portion in the scanning direction of the area of the sampling period T_{R1}, and the overlap between the R and G irradiation areas in the area of the sampling period T_{R2} spreading over the edges in the scanning direction of the R, G irradiation areas (the valley portion in the laser waveform) is preferably as small as possible. Color leaking occurs if the center in the scanning direction of the R irradiation area deviates from the center in the scanning direction of the area of the sampling period T_{R1}. Consequently, overlap between the R irradiation area and the irradiation area of another color (G, B) causes detection signals generated by irradiation of pulsed laser light of a plurality of colors to mix. Therefore, the detection signal is preferably relatively high in the sampling period T_{R1} and preferably relatively low in the sampling period T_{R2}. From this perspective, in the example in FIG. 10, the predetermined range of the sampling period T_{R1} is a range of a predetermined value S_{R1} or greater, and the predetermined range of the sampling period T_{R2} is a range of a predetermined value S_{R2} or less.

For example, the threshold (predetermined value S_{R1}) of the aforementioned predetermined range of the sampling period T_{R1} may be 90% of the peak amount of light, and the threshold (predetermined value S_{R2}) of the aforementioned predetermined range of the sampling period T_{R2} may be 10% of the peak amount of light.

When at least one of the detection signals in the sampling periods T_{R1}, T_{R2} is outside of the aforementioned predetermined ranges (S33: No), then the R irradiation timing t_{R} is changed (step S34), and the changed irradiation timing t_{R} is stored in the irradiation parameter table 50 of the memory 39. The R irradiation timing t_{R} is further adjusted by subsequently repeating steps S33 to S34 until both of the detection signals in the sampling periods T_{R1}, T_{R2} respectively fall within the aforementioned predetermined ranges (adjustment step).

On the other hand, when both of the detection signals in the sampling periods T_{R1}, T_{R2} respectively fall within the aforementioned predetermined ranges in step S33 (S33: Yes), the process proceeds to step S35, and a similar process as for R in steps S33 to S34 is performed for G. Specifically, it is judged whether the detection signals in the sampling period T_{G1} corresponding to the central half of the G pixel and in the following sampling period T_{G2} spreading into the G pixel and the B pixel are both within respective predetermined ranges for the sampling periods T_{G1}, T_{G2} (step S35). Here, as in the case of R, the detection signal is preferably relatively high in the sampling period T_{G1} and preferably relatively low in the sampling period T_{G2}. Hence, in the example in FIG. 10, the predetermined range of the sampling period T_{G1} is a range of a predetermined value S_{G1} or greater, and the predetermined range of the sampling period T_{G2} is a range of a predetermined value S_{G2} or less.

For example, the threshold (predetermined value S_{G1}) of the aforementioned predetermined range of the sampling period T_{G1} may be 90% of the peak amount of light, and the threshold (predetermined value S_{G2}) of the aforementioned predetermined range of the sampling period T_{G2} may be 10% of the peak amount of light.

When at least one of the detection signals in the sampling periods T_{G1}, T_{G2} is outside of the aforementioned predetermined ranges (S35: No), then the G irradiation timing to is changed (step S36), and the changed irradiation timing t_{G} is stored in the irradiation parameter table 50 of the memory 39. The G irradiation timing t_{G} is further adjusted by subsequently repeating steps S35 to S36 until both of the detection signals in the sampling periods T_{G1}, T_{G2} respectively fall within the aforementioned predetermined ranges (adjustment step).

Subsequently, a similar process as for R and G is performed for B (steps S37 to S38).

Adjustment of the irradiation parameter t (irradiation timings t_{R}, to, t_{B}) of each color R, G, B is completed by the above process.

According to the second embodiment, the detection signals obtained in the periods T_{R1}, T_{G1}, T_{B1} corresponding to the central half of a pixel can be increased above a predetermined value, and the detection signals obtained in the periods T_{R2}, T_{G2}, T_{B2} corresponding to half of a pixel and spreading into two sampling periods can be reduced below a predetermined value, thereby reducing overlap between adjacent irradiation areas of wavelengths of light. This reduces color leaking and improves image quality.

### Third Embodiment

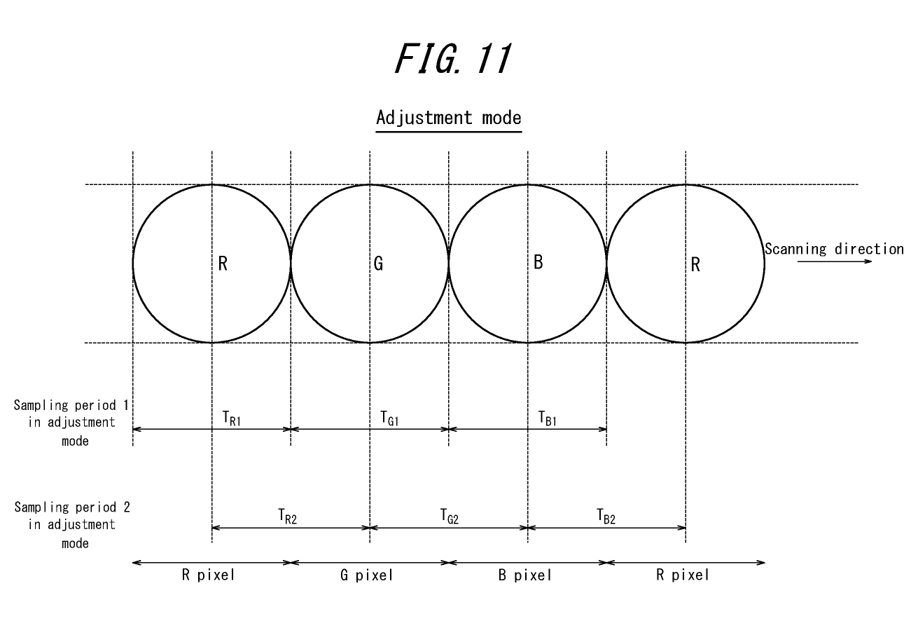

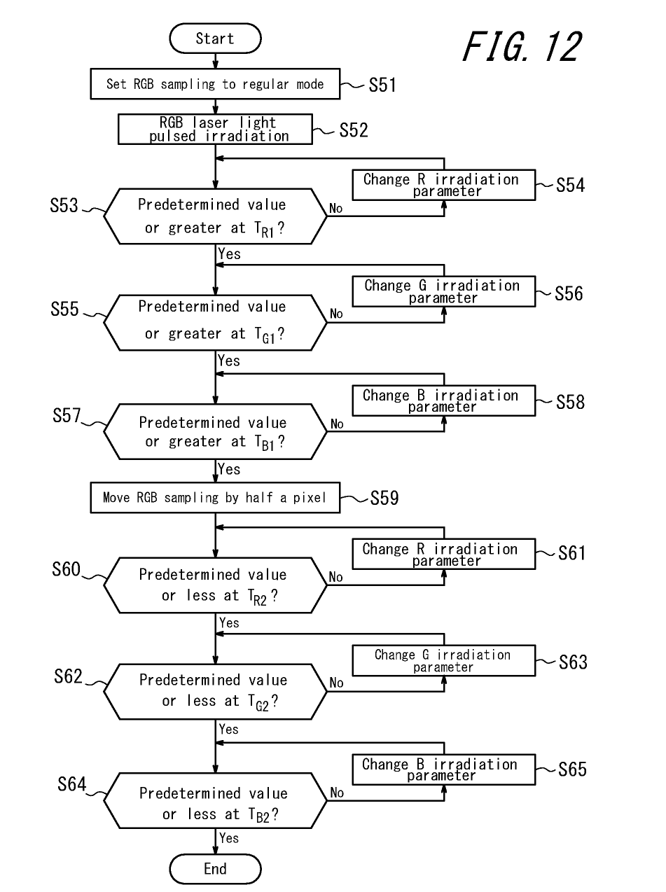

Next, a third embodiment of the disclosed method for adjusting an irradiation parameter of pulsed laser light is described with reference to FIGS. 11 and 12, focusing on the differences from the first embodiment. The optical scanning observation apparatus 10 described above with reference to FIGS. 1 to 4B is used in the below-described third embodiment of a method for adjusting an irradiation parameter.

In the third embodiment of a method for adjusting an irradiation parameter, as in the second embodiment, R, G, B pulsed laser light is emitted sequentially while scanning along a predetermined scan path. When a detection signal obtained by irradiation of pulsed laser light of one wavelength has a detection signal generated by irradiation of pulsed laser light of another wavelength mixed therein, an irradiation parameter of each pulsed laser light of at least one wavelength is adjusted to reduce the mixing of detection signals.

First, the R, G, B sampling periods in adjustment mode (and therefore the frequency and timing) are set to be the same as the sampling periods used in scanning mode (step S51).

As illustrated in FIGS. 11 and 12, the laser light source driver 32 sequentially outputs irradiation commands to the laser light sources 33R, 33G, 33B during a scan on the basis of the irradiation parameter t (irradiation timings t_{R}, t_{G}, t_{B}) stored in the irradiation parameter table 50 in the memory 39 to cause R, G, B pulsed laser light to be emitted sequentially (step S52, laser light source driving step). Step S52 is performed continuously while the following steps S53 to S65 are performed. The pulsed laser light from the laser light source 33 is irradiated onto the object 100 and scanned over the object 100 (scanning step) by the light-transmission fiber 11 and the actuator 21 (scanning unit). Light obtained from the object 100 is detected by the optical detector 35 in the sampling periods T_{R1}, T_{G1}, T_{B1} (optical detection step). The detection signals outputted from the optical detector 35 in the sampling periods T_{R1}, T_{G1}, T_{B1} are converted from analog to digital by the ADC 36.

Next, it is judged whether the detection signal in the R sampling period T_{R1} is within a predetermined range for the sampling period T_{R1} (step S53). The actual R irradiation area (solid circle) is ideally contained within the sampling area (scan area) of the R pixel. Accordingly, the detection signal is preferably relatively high in the sampling period T_{R1}. From this perspective, in the example in FIG. 12, the predetermined range of the sampling period T_{R1} is a range of a predetermined value S_{R1} or greater.

For example, the threshold (predetermined value S_{R1}) of the aforementioned predetermined range of the sampling period T_{R1} may be 90% of the peak amount of light.

When the detection signal in the sampling period T_{R1} is outside of the aforementioned predetermined range (S53: No), then the R irradiation timing t_{R} is changed (step S54), and the changed irradiation timing t_{R} is stored in the irradiation parameter table 50 of the memory 39. The R irradiation timing t_{R} is further adjusted by subsequently repeating steps S53 to S54 until the detection signal in the sampling period T_{R1} falls within the predetermined range of the sampling period T_{R1} (adjustment step).

On the other hand, when the detection signal in the sampling period T_{R1} falls within the aforementioned predetermined range in step S53 (S53: Yes), the process proceeds to step S55, and a similar process as for R in steps S53 to S54 is performed for G (steps S55 to S56).

Subsequently, a similar process as for R and G is performed for B (steps S57 to S58).

Next, the R, G, B sampling periods in adjustment mode are moved (in this example, delayed) by half a pixel from the sampling periods in scanning mode (step S59). It is then judged whether the detection signal in the R sampling period T_{R2} is within a predetermined range for the sampling period T_{R2} (step S60). Ideally, the overlap between R and G irradiation areas is as small as possible in the area of the sampling period T_{R2} that spreads into the R and G irradiation areas. Accordingly, the detection signal is preferably relatively low in the sampling period T_{R2}. From this perspective, in the example in FIG. 12, the predetermined range of the sampling period T_{R2} is a range of a predetermined value S_{R2} or less.

For example, the threshold (predetermined value S_{R2}) of the aforementioned predetermined range of the sampling period T_{R2} may be 10% of the peak amount of light.

When the detection signal in the sampling period T_{R2} is outside of the aforementioned predetermined range (S60: No), then the R irradiation timing t_{R} is changed (step S61), and the changed irradiation timing t_{R} is stored in the irradiation parameter table 50 of the memory 39. The R irradiation timing t_{R} is further adjusted by subsequently repeating steps S60 to S61 until the detection signal in the sampling period T_{R2} falls within the aforementioned predetermined range of the sampling period T_{R2} (adjustment step).

On the other hand, when the detection signal in the sampling period T_{R2} falls within the aforementioned predetermined range in step S60 (S60: Yes), the process proceeds to step S62, and a similar process as for R in steps S60 to S61 is performed for G (steps S62 to S63).

Subsequently, a similar process as for R and G is performed for B (steps S64 to S65).

Adjustment of the irradiation parameter t (t_{R}, t_{G}, t_{B}) of each color R, G, B is completed by the above process.

In addition to the effects of the second embodiment, the third embodiment makes it unnecessary to change the substrate of the control device body 30, which could be necessary in the second embodiment when setting the sampling frequency in adjustment mode to twice the sampling frequency in scanning mode.

This disclosure is not limited to the above-described embodiments, and a variety of modifications may be made.

In the above-described examples, the irradiation parameter t may include the pulse width of the R, G, B pulsed laser light in addition to, or instead of, the irradiation timing of the R, G, B pulsed laser light.

In each of the above-described examples, a portion or all of the steps in the method for adjusting an irradiation parameter may be performed in response to human operation of the optical scanning observation apparatus 10 or may be programmed and performed automatically by the optical scanning observation apparatus 10.

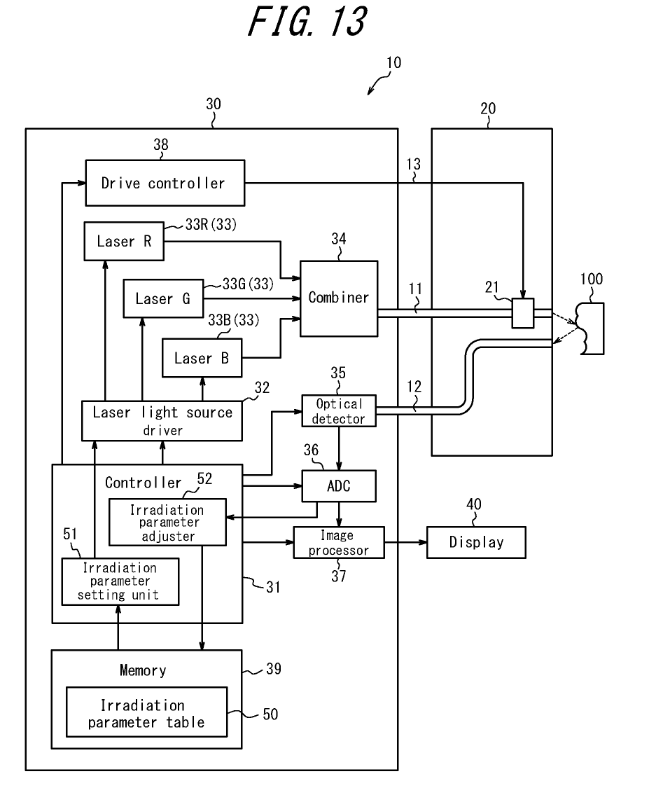

FIG. 13 illustrates an optical scanning observation apparatus 10 configured to allow execution of a program that includes a portion or all of the steps of the method for adjusting an irradiation parameter. The optical scanning observation apparatus 10 in FIG. 13 differs from the optical scanning observation apparatus 10 in FIG. 1 in that the controller 31 includes an irradiation parameter adjuster 52. The irradiation parameter adjuster 52 adjusts the irradiation parameter by executing the aforementioned program stored in a storage device, such as the memory 39, and stores the adjusted irradiation parameter in the irradiation parameter table 50 within the memory 39.

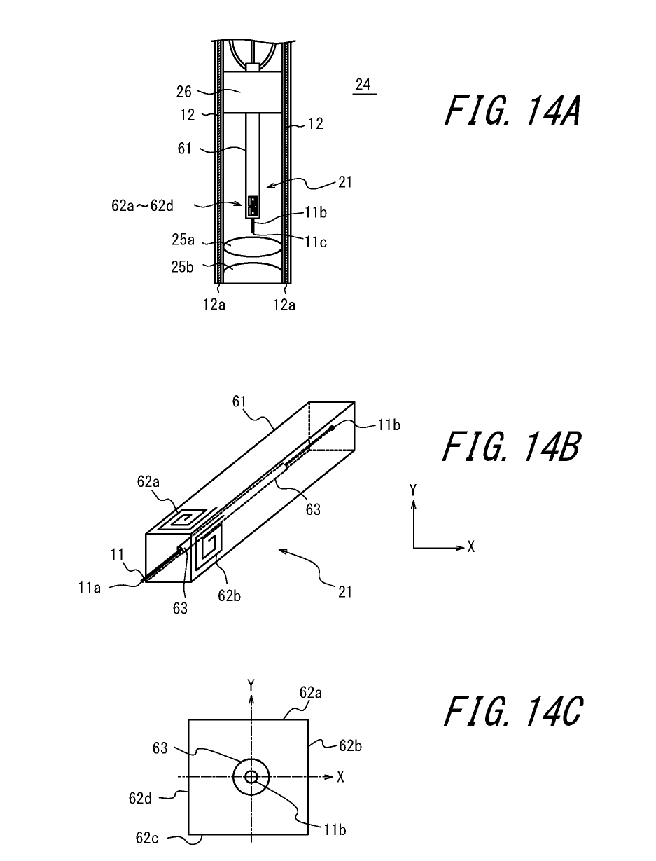

The actuator 21 of the light-transmission fiber 11 is not limited to use of piezoelectric elements. For example, a permanent magnet fixed to the light-transmission fiber 11 and coils for generation of a deflecting magnetic field (magnet coils) that drive the permanent magnet may be used instead. The following describes a modification to the actuator 21 with reference to FIGS. 14A to 14C. FIG. 14A is a cross-sectional view of the tip 24 of the scope 20, FIG. 14B is an enlarged perspective view of the actuator 21 in FIG. 14A, and FIG. 14C is a cross-sectional view along a plane perpendicular to the axis of the light-transmission fiber 11, illustrating a portion including the coils 62a to 62d for generation of a deflecting magnetic field and the permanent magnet 63 in FIG. 14B.

At a portion of the oscillating part 11b of the light-transmission fiber 11, the permanent magnet 63, which is magnetized in the axial direction of the light-transmission fiber 11 and includes a through-hole, is joined to the light-transmission fiber 11 by the light-transmission fiber 11 being passed through the through-hole. A square tube 61, one end of which is fixed to the attachment ring 26, is provided so as to surround the oscillating part 11b, and flat coils 62a to 62d for generation of a deflecting magnetic field are provided on the sides of the square tube 61 at a portion thereof opposing one pole of the permanent magnet 63.

The pair of coils 62a and 62c for generation of a deflecting magnetic field in the Y direction and the pair of coils 62b and 62d for generation of a deflecting magnetic field in the X direction are each disposed on opposing sides of the square tube 61, and a line connecting the center of the coil 62a for generation of a deflecting magnetic field with the center of the coil 62c for generation of a deflecting magnetic field is orthogonal to a line connecting the center of the coil 62b for generation of a deflecting magnetic field with the center of the coil 62d for generation of a deflecting magnetic field near the central axis of the square tube 61 when the light-transmission fiber 11 is disposed therein at rest. These coils are connected to the drive controller 38 of the control device body 30 via the wiring cables 13 and are driven by drive current from the drive controller 38.

Furthermore, the scanning unit is not limited to oscillating the tip of an optical fiber. For example, an optical scanning element such as a MEMS mirror may be disposed along the optical path from the laser light source 33 to the object.

The optical scanning observation apparatus of the present disclosure may also be configured as an optical scanning microscope.

1. An optical scanning observation apparatus comprising:
a laser light source driver configured to emit pulsed laser light of different wavelengths sequentially from a plurality of laser light sources;
a scanning unit configured to irradiate the pulsed laser light on an object to scan the object;
a laser light detector configured to sequentially detect light obtained from the object by sequential irradiation of the pulsed laser light;
an image processor configured to generate an image of the object based on a detection signal outputted from the laser light detector; and
a controller configured to control an irradiation parameter of the plurality of laser light sources; wherein
the irradiation parameter is an irradiation command timing or a pulse width; and
the controller corrects the irradiation parameter of each color from the plurality of laser light sources in advance and controls the laser light source driver using the corrected irradiation parameter.

2. The optical scanning observation apparatus of claim 1, wherein the controller is configured to judge, in an adjustment mode for adjusting the irradiation parameter, whether a detection signal outputted from the laser light detector during a predetermined sampling period falls within a predetermined range relative to the predetermined sampling period.

3. The optical scanning observation apparatus of claim 2, wherein when the detection signal outputted from the laser light detector during the predetermined sampling period is outside of the predetermined range relative to the predetermined sampling period, the controller is configured to change an irradiation parameter of each pulsed laser light of at least one wavelength so that the detection signal falls within the predetermined range.

4. A method for adjusting an irradiation parameter of pulsed laser light, the method comprising:
driving a laser light source to emit pulsed laser light from the laser light source;
irradiating the pulsed laser light on an object to scan the object;
detecting light obtained from the object by irradiation of the pulsed laser light; and
adjusting an irradiation parameter of the pulsed laser light, when a detection signal obtained in the detecting during a predetermined sampling period is outside of a predetermined range relative to the predetermined sampling period, so that the detection signal falls within the predetermined range; wherein
the irradiation parameter is an irradiation command timing or a pulse width.

5. A method for adjusting an irradiation parameter of pulsed laser light, the method comprising:
driving a plurality of laser light sources to emit pulsed laser light of different wavelengths sequentially from the plurality of laser light sources;
irradiating the pulsed laser light on an object to scan the object;
detecting light obtained from the object by sequential irradiation of the pulsed laser light; and
adjusting an irradiation parameter of each pulsed laser light of at least one wavelength, when a detection signal obtained in the detecting by irradiation of the pulsed laser light of one wavelength has mixed therein a detection signal generated by irradiation of the pulsed laser light of a different wavelength, to reduce mixing of the detection signals; wherein
the irradiation parameter is an irradiation command timing or a pulse width.

6. The method for adjusting an irradiation parameter of claim 5, wherein the irradiation parameter of each pulsed laser light of at least one wavelength is adjusted when a detection signal obtained in the detecting during a predetermined sampling period is outside of a predetermined range relative to the predetermined sampling period.
